(19) United States
(12) Patent Application Publication
(10) Pub. No.: US 2018/0256942 A1
(43) Pub. Date: Sep. 13, 2018

(54) Swim goggle with direction assist

(71) Applicant: William K. Love, Kentfield, CA (US)

(72) Inventor: William K. Love, Kentfield, CA (US)

(21) Appl. No.: 15/530,867

(22) Filed: Mar. 13, 2017

(51) Int. Cl. A63B 33/00; H04N 7/18; H04N 5/225; H04N 7/10; H04N 5/232; B63C 11/20

(52) U.S. Cl. CPC A63B 33/002; H04N 7/185; H04N 5/2252; H04N 7/10; H04N 5/23241; A63B 2220/833; B63C 11/205; A63B 2208/03; A63B 2220/12; A63B 2220/806; H04N 5/23296

(57) ABSTRACT

A swim goggle with direction assist having a video camera in a housing, a video monitor, a video processing circuit, a power supply, a strap and a swim goggle lens set. The camera is enclosed within the camera housing. The monitor is housed in a transparent protrusion on one side of one of the goggle lens facing the user's eye. The video processing circuit and power supply are housed within a pocket located on the flexible strap. The camera housing is mounted on the flexible strap and located on the back portion of a swimmer's head so that when he has his face directed own into the water the camera is facing forward and its viewing path is approximately horizontal to the water allowing the swimmer to locate key visual indicators in front of him, allowing him to stay on course without lifting his head out of the water.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of swimming aids and more specifically to a swim goggle with video camera and monitor providing direction assistance to the user.

When competitive swimmers are moving forward in the water it is necessary for them to stay on course to achieve the best time. Open water swimmers must look up periodically to view a visual indicator, be it a floating buoy or an object on shore, and to then correct their course so that they are moving as straight a direction as possible within the context of the agreed upon course. The action of looking up and then adjusting direction is time consuming and can be the difference in winning or losing a race.

One way of helping a swimmer to stay on course would be to use a GPS system and provide audible cues to the swimmer. This was proposed in U.S. Pat. No. 6,837,827 by Wa; C. Lee et al. However, this system requires that the swimmer pre-set the route that he or she is swimming which can be time consuming and complicated. Additionally; The GPS signal may be inhibited by the presence of water since the antenna may be underwater for periods of time. Finally, there may be swimming locations that do not have an Internet signal.

Other devices allow for water resistant head mounting video cameras that can allow a swimmer the ability to record his or her swimming activity. But there is no monitor placed near the user's eye to let him see what the camera sees. The new Goggle Glass product includes a small monitor that faces the user's eye but does not include a camera that is placed in the proper orientation for a swimmer to use while swimming. Additionally, the Goggle Glass product is not water resistant.

### BRIEF SUMMARY OF THE INVENTION

The primary object of the invention is to provide a swim goggle that includes a built in video camera and micro monitor that allows a swimmer to check the direction of their swimming course without having to lift his or her head out of the water.

Another object of the invention is to provide a direction assist swim goggle that attaches the camera to the strap at the rear of the user's head and pointed forward, in a parallel path to the water surface, when the swimmer has his face in the water.

Another object of the invention is to provide a direction assist swim goggle that positions the micro monitor on one side of the swim goggle lens and facing the user's eye.

A further object of the invention is to provide a direction assist swim goggle that encloses the cable assembly and video processing circuit within a hollow portion of the swim goggle headband.

Another object of the invention is to provide a direction assist swim goggle whose electronic components are enclosed in a water resistant fashion.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a swim goggle with direction assist comprising: a digital video camera member, a camera housing, a micro video monitor member, a first connecting cable, a second connecting cable, a video processing circuit, a rechargeable power supply, a flexible strap, a swim goggle lens set, said digital camera member enclosed within said camera housing, said micro video monitor member housed in a transparent hollow protrusion within one side of one of said goggle lens, said video processing circuit and said rechargeable power, supply housed within a pocket located on said flexible strap, said first connecting cable connecting said digital video camera member to said video processing circuit, said second connecting cable connecting said video processing circuit to said micro video monitor member, said first and second connecting cables housed within said pocket in said flexible strap, said strap connected on each end to said goggle lens set, said rechargeable power supply supplying electrical power to all electrical components and housed within said pocket on said flexible strap, and said strap pocket, said camera housing and said hollow camera protrusion all being water resistant.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the invention being worn by a swimmer.

FIG. 2 is a top section view of the invention.

FIG. 3 is a front view of one lens of the goggle of the invention.

FIG. 4 is a side section view of the camera housing.

FIG. 5 is a top view of the camera housing.

FIG. 6 is a perspective view of an alternate embodiment of the invention.

FIG. 7 is a perspective view of a second alternate embodiment of the invention.

FIG. 8 is a perspective view of a third alternate embodiment of the invention.

FIG. 9 is a perspective view of a fourth alternate embodiment of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

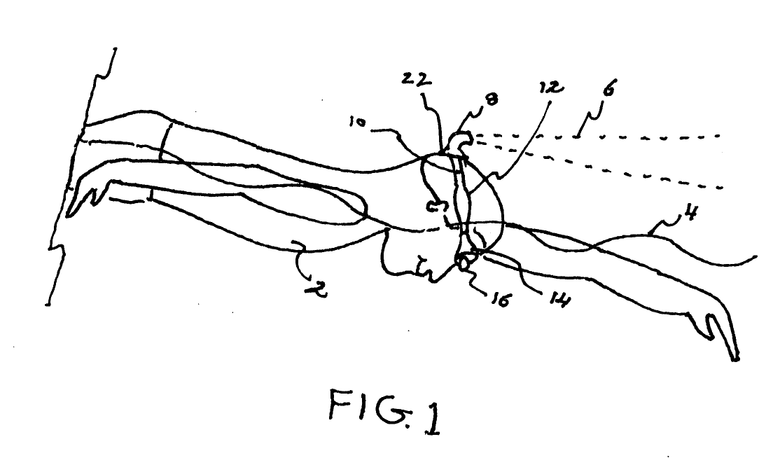

Referring now to FIG. 1 we see a side view of a person 2 swimming in water 4 with his face pointing down. This downward facing position is the normal orientation of the swimmers head, except for the relatively brief times when he is turning his head to one side or the other to inhale air. The swimmer is wearing a specially designed swim goggle 14 that includes a housing 16 that holds a tiny video monitor that faces the user's eye. A video camera is installed within transparent rigid housing 8 and mounted on the strap via a mounting pad 22. The video viewing angle is represented by dash lines 6. Because of the mounting position of the camera 24, the swimmer 2 can view objects in front of him or her without needing to lift his or her head thereby saving valuable swim time normally taken by lifting the head out of the water to check direction of destination.

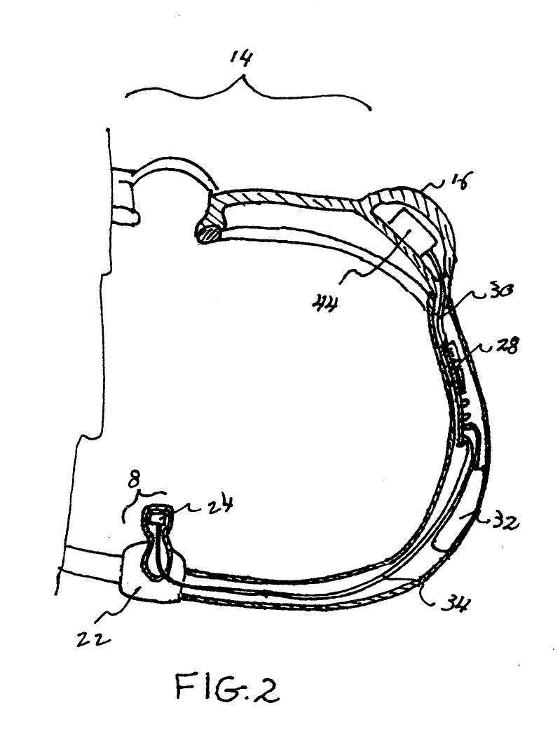

FIG. 2 shows a top plan section view of the invention. The side strap 10 includes a flexible water resistant housing 12 that holds a cable 30 that connects the video monitor 24 to a video processing circuit 28. Another cable 34 connects the video processing unit to the micro monitor 44. A battery power supply 32 supplies electricity to all electronic components.

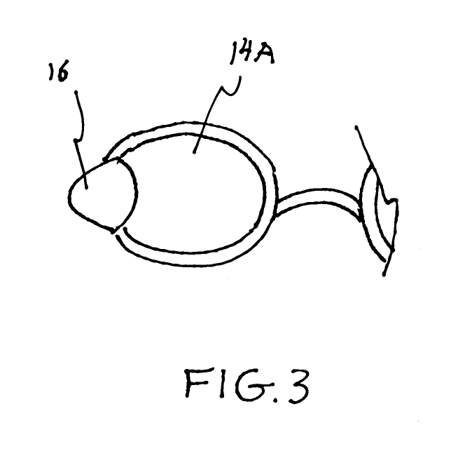

FIG. 3 shows a partial front view of the goggle showing the lens 14A which has the monitor housing 16 incorporated. The location of the monitor is such that the view of the wearer is not obstructed, but the wearer can shift his or her eye to one side to view the monitor when so desired.

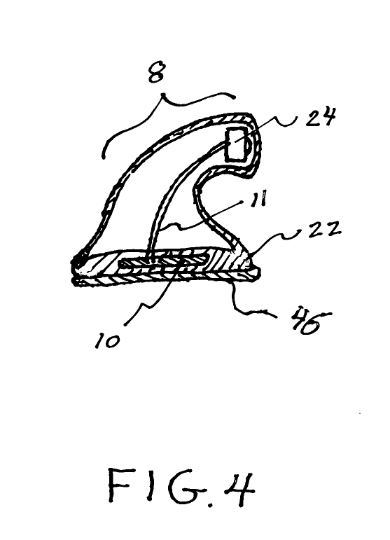

FIG. 4 is a side section view of the camera housing 8 which holds camera 24. An aperture within the base plate 22 of housing 8 holds swim strap 10. The base plate can be slid left or right on the swim goggle strap 10 to insure that it is located in the ideal position as established by the user. The camera 24 resides approximately one inch above the base plate 22 thereby giving a clear, unobstructed view of objects located in front of the swimmer.

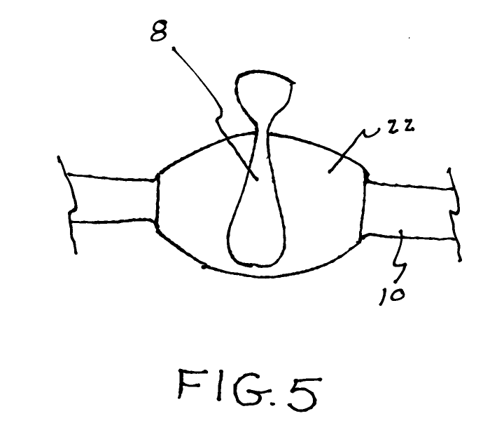

FIG. 5 is a top view of the camera housing 8. The portion holding the camera 8A is as wide as needed to house the camera, but then reduces to a teardrop shape 8B to reduce resistance from oncoming water.

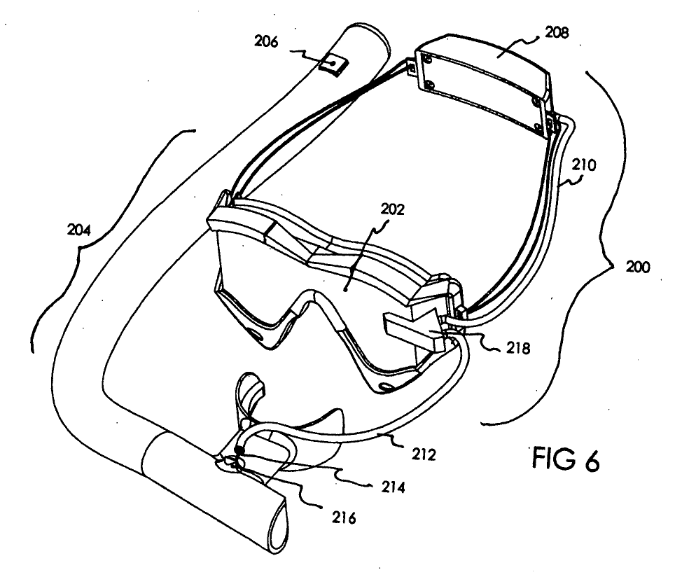

FIG. 6 is a perspective view of an alternate embodiment 200 of the invention: In this embodiment the camera 206 is mounted within a standard snorkel device 204. A cable that is internal to the snorkel tube 204 terminates at female connector 216. A second cable 212 terminates in a waterproof male connector 214. The other end of cable 212 terminates at the outer housing of display member 218. Cable 210 transmits information from the camera 206 as well as video information coming from to the micro processor electronics housing 208. In this way, a scuba diver can continue to look down into the water without needing to pick up his or her head to check location with respect to land or a boat or other orientation point.

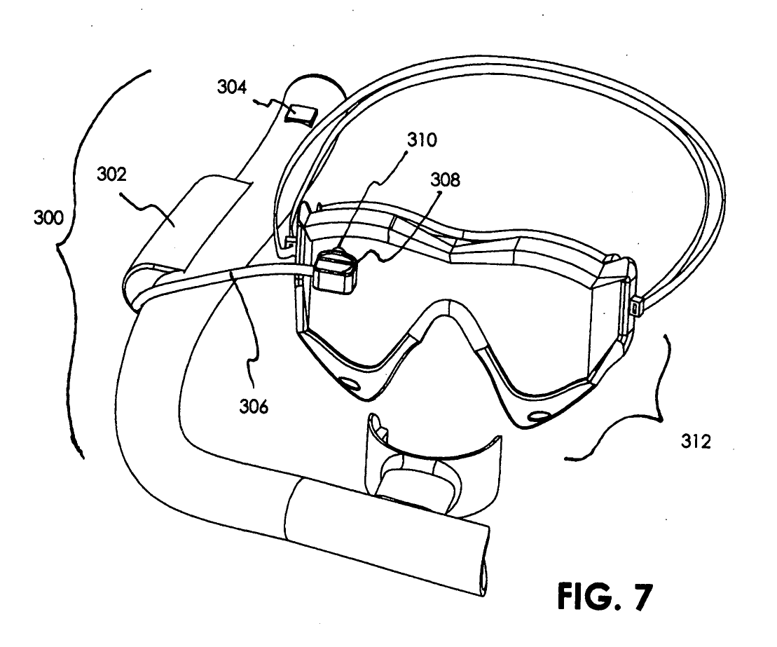

In a second version of the alternate embodiment as shown in FIG. 7, the housing 302 for the micro processor is integral to the snorkel tube 300. Camera 304 is similarly placed as the original alternate embodiment. The display housing 308 is held onto the front of the mask 312 via suction cups 310. A cable 306 attaches the display 308 to the micro processor electronics housing 302. In this way, a person can use his or her own mask and separately purchase the snorkel 300 with the attached camera 302, electronics processor circuit 320 and display unit 308 included in one integrated assembly.

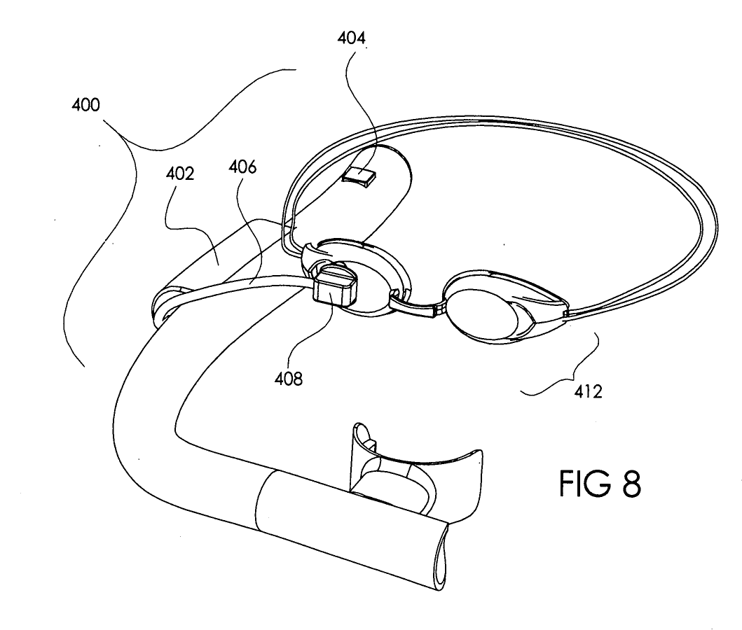

FIG. 8 is a third alternate embodiment 400 if the invention which shows the electronics housing 402 and camera 404 attached to the snorkel tube while the cable 406 is attached to the display housing 408 which is mounted to a standard pair of swim goggles 412.

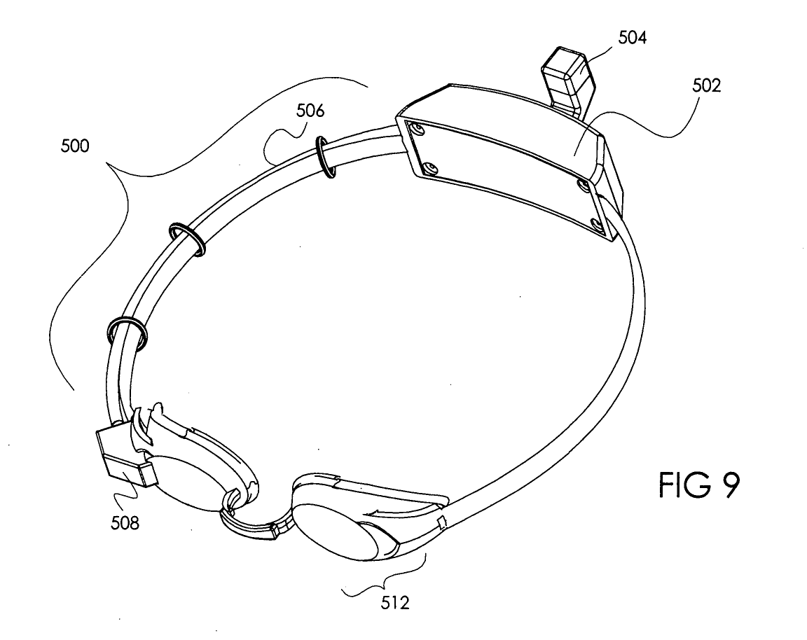

FIG. 9 is a fourth alternate embodiment 500 which shows the microprocessor housing 502 and attached camera 504 mounted to the back of strap a swim goggle strap. Cable 506 connects the micro display 508 to the electronics housing 502. The swim goggle design is ideal for people who are simply swimming and not necessarily snorkeling.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. swim goggle with direction assist comprising:
a digital video camera member;
a camera housing;
a micro video monitor member;
a first connecting cable;
a second connecting cable;
a video processing circuit;
a rechargeable power supply;
a flexible strap;
a swim goggle lens set;
said digital camera member enclosed within said camera housing;
said micro video monitor member housed in a transparent hollow protrusion within one side of one of said goggle lens;
said video processing circuit and said rechargeable power supply housed within a pocket located on said flexible strap;
said first connecting cable connecting said digital video camera member to said video processing circuit;
said second connecting cable connecting said video processing circuit to said micro video monitor member;
said first and second connecting cables housed within said pocket in said flexible strap;
said strap connected on each end to said goggle lens set;
said rechargeable power supply supplying electrical power to all electrical components and housed within said pocket on said flexible strap; and
said strap pocket, said camera housing and said hollow camera protrusion all being water resistant.

2. A swim goggle with direction assist as claimed in claim 1 wherein said camera housing is mounted on said flexible strap and is located on the back portion of a swimmer's head so that when a swimmer wearing said swim goggle has his face directed own into the water said camera is facing forward and its viewing path is approximately horizontal to the water allowing said swimmer to locate key visual indicators in front of him that allows him to stay on course without lifting his head out of the water.

3. A swim goggle with direction assist as claimed in claim 1 wherein an alternate embodiment includes the installation of said digital video camera into the upper portion of a standard snorkel device;
said micro video monitor member attached to one side of a standard swimmer's mask and electrical cables that connect said digital video camera and said micro video monitor to said video processing circuit.

4. A swim goggle with direction assist as claimed in claim 3 wherein a second alternate embodiment said snorkel includes the inclusion of a housing for said video processing circuit and where said micro monitor is attached to the front of said mask via suction cups.
